(19) United States
(12) Patent Application Publication
(10) Pub. No.: US 2004/0124133 A1
(43) Pub. Date: Jul. 1, 2004

(54) Process for producing spiral membrane element

(75) Inventors: Kaoru Irie, Ibaraki-shi (JP); Tomohiro Inagaki, Ibaraki-shi (JP); Tatsuya Ogurisu, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 10/704,671

(22) Filed: Nov. 12, 2003

(30) Foreign Application Priority Data
Dec. 25, 2002 (JP) P. 2002-374624

(51) Int. Cl. B01D 63/10

(52) U.S. Cl. 210/321.83; 210/321.74

(57) ABSTRACT

A process for spiral membrane element production is disclosed which attains high productivity, eliminates the material “wrinkling” or “breakage” caused by material distortion or core tube distortion, and can increase the degree of tightening of the whole element. The process includes a step in which a multilayer structure including a feed-side passage material interposed between opposed membranes on their feed side and a permeation-side passage material interposed between opposed membranes on their permeation side is spirally wound on a perforated core tube, wherein the winding of the multilayer structure on the core tube is conducted by rotating the core tube 5 while pressing one or more rolls 15 against the periphery of the wound structure R1.

### FIELD OF THE INVENTION

The present invention relates to a process for producing a spiral membrane element for separating a specific ingredient from various fluids (liquids or gases). More particularly, the invention relates to an improvement in a winding method for spiral membrane element production.

### DESCRIPTION OF THE RELATED ART

Spiral membrane elements heretofore in use are known to have a structure obtained by disposing a permeation-side passage material to the permeation side of two membranes, sealing three sides of the membranes to form a layered product of a bag shape, connecting a set of such layered products (membrane leaves) to a perforated core tube, and spirally winding the connected layered products together with feed-side passage materials interposed therebetween. Further, an element is known which employs two or more sets of such layered products (membrane leaves) so as to reduce the permeation-side passage length.

The basic structure of the latter element generally comprises a perforated core tube and spirally wound thereon a multilayer structure including a feed-side passage material interposed between opposed membranes on their feed side and a permeation-side passage material interposed between opposed membranes on their permeation side and further has a sealing structure for preventing the feed-side passages from being directly connected to the permeation-side passages. More specifically, an element is already known which comprises a perforated core tube and wound therearound either a membrane assembly composed of a twice-folded membrane leaf comprising membranes and a feed-side passage material sandwiched therebetween on their separating layer side and a permeation-side passage material disposed adjacently to the membrane leaf or a multilayer structure comprising two or more such membrane assemblies (see, for example, U.S. Pat. No. 3,417,870 (page 1)).

A generally known process for producing such a spiral membrane element is a tension method which comprises producing a multilayer structure comprising membrane assemblies and then winding the multilayer structure on a core tube while applying a tension to a permeation-side passage material bonded to the core tube. In this method, the following procedure is employed as shown in FIG. 5(a) to (c). First, a membrane leaf 3 comprising a membrane 1 and a feed-side passage material 2 is superposed on a permeation-side passage material 4. Membrane assemblies each obtained in this manner are stacked so as to shift the respective positions of the assemblies at a given interval (the length obtained by dividing the length of the periphery of a core tube 5 by the number of the membrane leaves 3) to produce a multilayer structure. Subsequently, the multilayer structure is wound on the core tube 5 using a permeation-side passage material 4a bonded beforehand to the core tube 5, while applying a tension to the passage material 4a. Although FIG. 5 illustrates an example having a constitution in which the membrane leaves 3 are independent and incontinuous (independent leaves), a constitution is also known in which the membranes 1 of the respective membrane leaves 3 are continuous.

However, such processes heretofore in use for producing a spiral membrane element have had the following various problems. (1) Since an adhesive is used for bonding the membrane leaves to permeation-side passage materials, slippage between members is poor and this is apt to cause “breakage” or “wrinkling” to the material and necessitates low-speed winding, resulting in poor productivity. (2) When too high a tension is applied in an initial stage, the core tube may bend to distort the material, resulting in “wrinkling” or “breakage”. (3) A difference in height may arise according to the thickness of the adhesive, resulting in material distortion. (4) When a folded multilayer structure in a continuous pleat form is wound, the material is inevitably distorted according to the degree of material position shifting and due to the difference in material thickness, difference in tension between both sides, etc. (5) Since winding is conducted at a low speed with the lowest possible torque so as to prevent material distortion, there are cases where a base part or the whole of the multilayer structure is not tightened.

### SUMMARY OF THE INVENTION

Accordingly, an object of the present invention is to provide a process for spiral membrane element production which attains high productivity, eliminates the material “wrinkling” or “breakage” caused by material distortion or core tube distortion, and can increase the degree of tightening of the whole element.

As a result of intensive investigations, it has been found that the object can be accomplished by winding a multilayer structure comprising membrane assemblies on a core tube while pressing one or more rolls against the periphery of the wound structure. The invention has been achieved based on this finding.

The present invention provides a process for producing a spiral membrane element which comprises: the step of forming a multilayer structure including a feed-side passage material interposed between opposed membranes on their feed side and a permeation-side passage material interposed between opposed membranes on their permeation side; the step of spirally winding at least the multilayer structure on a perforated core tube; and the step of forming a sealing structure for preventing the feed-side passages from being directly connected to the permeation-side passages, the winding of the multilayer structure on the core tube being conducted by rotating the core tube while pressing one or more rolls against the periphery of the wound structure.

The process preferably includes a step in which during or after completion of the winding, the wound structure is tightened by rotating the core tube while pressing one or more rolls against the wound structure at a higher pressure.

The process preferably further includes a step in which during or after completion of the tightening step, a sheathing sheet is wound on the wound structure while pressing one or more rolls against the wound structure.

Furthermore, the step of forming a multilayer structure preferably comprises a step in which permeation-side passage materials are fixed each at an end thereof to a porous sheet at a given interval and a step in which a membrane and a feed-side passage material are inserted between the fixed permeation-side passage materials to thereby form the multilayer structure.

In the tension method heretofore in use, even winding is possible at an even pressure if the members undergo ideal slippage on each other. Virtually, however, smooth slippage does not occur and pressure unevenness arises to cause distortion. This distortion is enhanced on the periphery side. Furthermore, the core tube bends especially due to the tension applied in an initial stage and this is apt to result in material distortion. In contrast, according to the invention, the winding of a multilayer structure on a core tube is conducted by rotating the core tube while pressing one or more rolls against the periphery of the wound structure. Due to this constitution, winding can be carried out at an even pressure generated by the roll pressing pressure. Because of this, the multilayer structure can be wound evenly at a sufficient speed and pressure even in an initial stage of winding, and the material distortion caused by core tube bending is less apt to occur. As a result, high productivity is attained and the problem of material “wrinkling” or “breakage” caused by material distortion or core tube distortion is eliminated. In addition, the degree of tightening of the whole element can be heightened.

When the process includes a step in which during or after completion of the winding, the wound structure is tightened by rotating the core tube while pressing one or more rolls against the wound structure at a higher pressure, then a pressure is transmitted even to inner parts due to the roll pressing pressure. Because of this, the wound structure can be wholly tightened at a relatively even pressure. In the tension method heretofore in use, inner parts cannot be tightened at an even pressure even when the tension is increased during or after completion of the winding.

When the process includes a step in which during or after completion of the tightening step, a sheathing sheet is wound on the wound structure while pressing one or more rolls against the wound structure, then the sheathing sheet can be wound at an even pressing pressure. As a result, an evenly tightened state can be maintained.

When the step of forming a multilayer structure comprises a step in which permeation-side passage materials are fixed each at an end thereof to a porous sheet at a given interval and a step in which a membrane and a feed-side passage material are inserted between the fixed permeation-side passage materials to thereby form the multilayer structure, then the fixing operation can be satisfactorily performed to give a composite material with satisfactory handleability because the respective ends of permeation-side passage materials are fixed not to a core tube but to a porous sheet at a given interval. In addition, since the composite material has a simple shape, the operation for inserting a membrane, etc. is easy. By winding this porous sheet after the insertion on a core tube, the multilayer structure can be easily wound spirally on the core tube without causing positional shifting.

### BRIEF DESCRIPTION OF THE DRAWINGS

FIG. 1 is views diagrammatically illustrating steps of one embodiment of the process for spiral membrane element production of the invention.

FIG. 2 is views illustrating, in more detail, part of a step shown in FIG. 1.

FIG. 3 is views illustrating, in more detail, part of the step shown in FIG. 1.

FIG. 4 is a view diagrammatically illustrating one embodiment of the process for spiral membrane element production of the invention.

FIG. 5 is views diagrammatically illustrating one example of conventional process for spiral membrane element production.

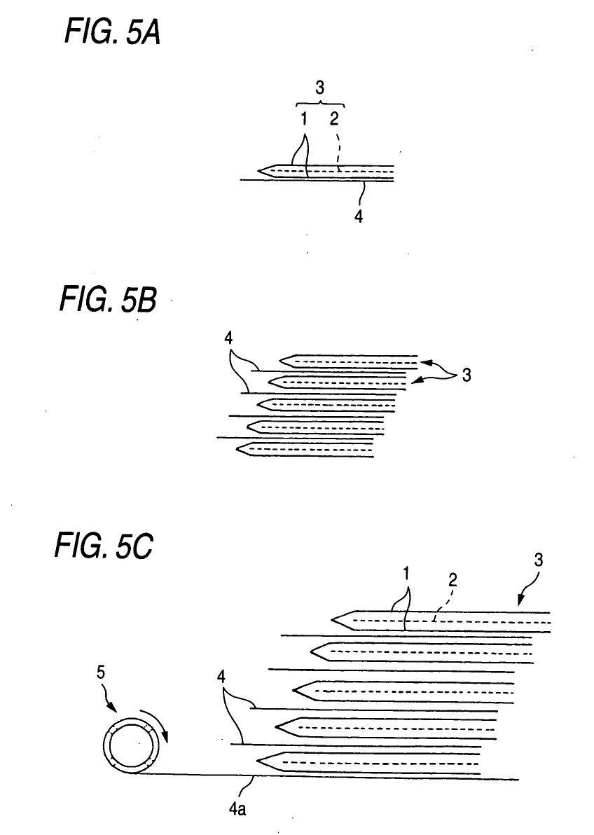

In the drawings:

1 membrane

2 feed-side passage material

4 permeation-side passage material

core tube

porous sheet

roll

16 sheathing sheet

S1 multilayered object

S2 multilayer structure

R1 wound structure

### DETAILED DESCRIPTION OF THE INVENTION

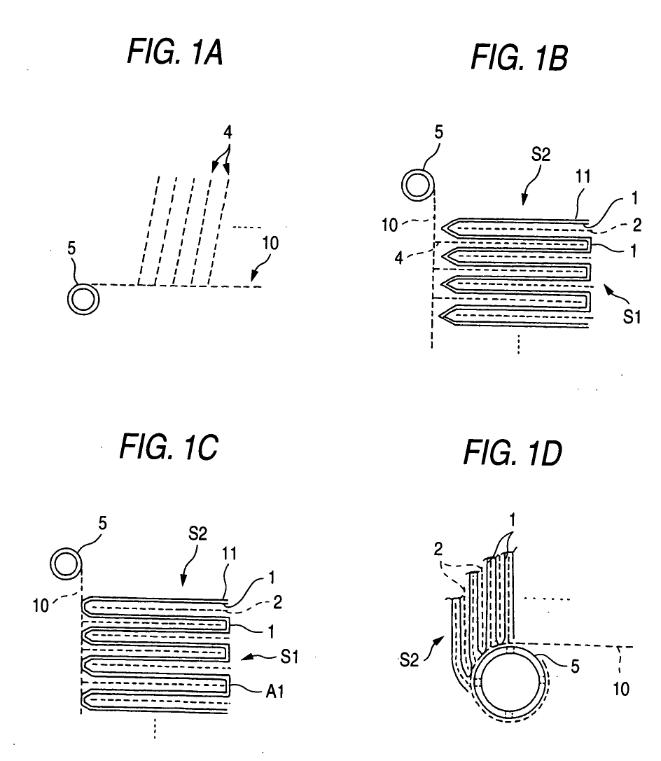

The embodiment of the present invention will be explained below by reference to the accompanying drawings. FIG. 1(a) to FIG. 4(b) are diagrammatic views illustrating steps of one embodiment of the process for spiral membrane element production of the invention.

The process of the invention includes the step of forming a multilayer structure S2 which includes a feed-side passage material 2 interposed between opposed membranes 1 on their feed side and a permeation-side passage material 4 interposed between opposed membranes 1 on their permeation side, as shown in FIG. 1(b). In this embodiment, the step of forming a multilayer structure S2 comprises a step in which permeation-side passage materials 4 are fixed each at an end thereof to a porous sheet 10 at a given interval and a step in which a membrane 1 and a feed-side passage material 2 are inserted between the fixed permeation-side passage materials 4 to thereby form the multilayer structure S2, as shown in FIG. 1(a) and (b). In this embodiment, the core tube 5 serves as a permeation-side passage (e.g., water-collecting core tube).

The feed-side passage material 2 can use any conventional feed-side passage materials for use in spiral membrane elements. Examples of the material include nets, meshes, woven filament fabrics, woven fiber fabrics, nonwoven fabrics, grooved sheets, corrugated sheets, and the like. Such feed-side passage materials may be made of a resin such as polypropylene, polyethylene, poly(ethylene terephthalate) (PET), polyamide, or the like or any of natural polymers, rubbers, metals, and the like. However, in the case where dissolution from the passage materials may pose a problem in a separation operation or the like, it is preferred to take account of this dissolution in selecting a material.

The thickness of the feed-side passage material 2 is preferably from 0.3 mm to 2 mm. The feed-side passage material 2 preferably has a thickness-direction porosity of from 10% to 95%. In the case where the feed-side passage material 2 is a net, it preferably has a pitch of from 0.5 mm to 10 mm.

The permeation-side passage materials 4 can use any conventional permeation-side passage materials for spiral membrane elements. Examples of the material include nets, meshes, woven filament fabrics, woven fiber fabrics, nonwoven fabrics, grooved sheets, corrugated sheets, and the like. Such permeation-side passage materials may be made of a resin such as polypropylene, polyethylene, poly(ethylene terephthalate) (PET), polyamide, epoxy, urethane, or the like or any of natural polymers, rubbers, metals, and the like. However, in the case where dissolution from the passage materials may pose a problem in a separation operation or the like, it is preferred to take account of this dissolution in selecting a material.

The thickness of each permeation-side passage material 4 is preferably from 0.1 mm to 2 mm. The permeation-side passage materials 4 preferably have a thickness-direction porosity of from 10% to 80%. In the case where each permeation-side passage material 4 is a net, it preferably has a pitch of from 0.3 mm to 5 mm.

The porous sheet 10 may be any sheet which is permeable to fluids at least in some degree. Any of the permeation-side passage materials 4 which satisfy this requirement can be used. Preferred examples of the form of the porous sheet 10 include net, mesh, woven filament fabric, and the like. The percentage of openings or porosity of the porous sheet 10 is preferably from 10 to 80%, more preferably from 40 to 80%. In the case where passage materials are to be fixed to the porous sheet 10 by thermal fusion bonding or ultrasonic fusion bonding, it is preferred that the passage materials and porous sheet 10 selected should be made of the same material or be fusion-bondable materials.

Besides thermal fusion bonding and ultrasonic fusion bonding, examples of the fixing method include bonding with an adhesive, bonding with a pressure-sensitive adhesive tape or a material for thermal fusion bonding, and mechanical connection by suture or with staples or the like. Any of these may be used. An overlap width may be taken for the fixing. The parallelism between the permeation-side passage materials 4 in the fixing is preferably from 0.01 to 1 degree, and the parallelism with the core tube 5 is preferably from 0.01 to 1 degree.

Even when passage materials are fixed to a porous sheet 10 at different intervals, the intervals can be corrected, for example, by regulating the positioning of membranes, etc. However, it is preferred to fix passage materials at almost the same interval. In the case where passage materials are to be fixed at almost the same interval, this interval preferably is the length obtained by dividing the length of the periphery of the core tube 5 by the number of the passage materials to be fixed.

In this embodiment, the porous sheet 10 is partly fixed beforehand to the core tube 5 as shown in FIG. 1(a). This step may be conducted at any stage before the porous sheet 10 and other members are wound on the core tube 5. For example, this step may be conducted before or immediately after the fixing of the passage materials to the porous sheet 10 or just before the porous sheet 10 and other members are wound on the core tube 5.

The core tube 5 can use any conventional core tubes. For example, a perforated core tube made of a metal, fiber-reinforced plastic, plastic, ceramic, or the like may be used. The shape, size, positions, and number of holes each may be any of known ones according to the kind of the membranes, etc.

The outer diameter and length of the core tube 5 are suitably determined according to the size of the spiral membrane element. For example, the core tube 5 has an outer diameter of from 10 to 100 mm and a length of from 500 to 2,000 mm, and preferably has an outer diameter of from 12 to 38 mm and a length of from 900 to 1,200 mm.

Besides thermal fusion bonding and ultrasonic fusion bonding, examples of methods for fixing the porous sheet 10 to the core tube 5 include bonding with an adhesive, bonding with a pressure-sensitive adhesive tape, double-faced pressure-sensitive adhesive tape, or material for thermal fusion bonding, and mechanical fixing. Any of these may be used. The part to be fixed is not particularly limited as long as the porous sheet 10 is fixed at least partly. It is, however, preferred that an end of the porous sheet 10 be fixed throughout the whole length of the end side, from the standpoint of satisfactorily conducting the winding step. It is possible to wind the porous sheet 10 beforehand on the core tube 5 to make from 1 to 10 laps, preferably from 1 to 3 laps.

Subsequently, as shown in FIG. 1(b), a membrane 1 and feed-side passage materials 2 are inserted between the permeation-side passage materials 4 fixed to the porous sheet 10. Thus, a multilayer structure S2 is formed which includes the feed-side passage materials 2 interposed between opposed parts of the membrane 1 on their feed side and the permeation-side passage materials 4 interposed between opposed parts of the membrane 1 on their permeation side. In this embodiment, for the insertion of the membrane 1 and the feed-side passage materials 2, a multilayered object S1 is prepared beforehand which comprises a pleated continuous membrane and feed-side passage materials 2 disposed beforehand on the feed side of the membrane.

The membrane used in the invention is not particularly limited as long as it is a porous membrane or nonporous membrane having a pressure loss in permeation not lower than a given level. Examples thereof include microfiltration membranes, ultrafiltration membranes, nanofiltration membranes, reverse osmosis membranes, ion-exchange membranes, gas permeation membranes, and dialysis membranes. The material of the membrane can use a polymer such as a polyolefin, e.g., polypropylene or polyethylene, polysulfone, polyethersulfone, polystyrene, polyacrylonitrile, cellulose acetate, polyamide, polyimide, or fluororesin.

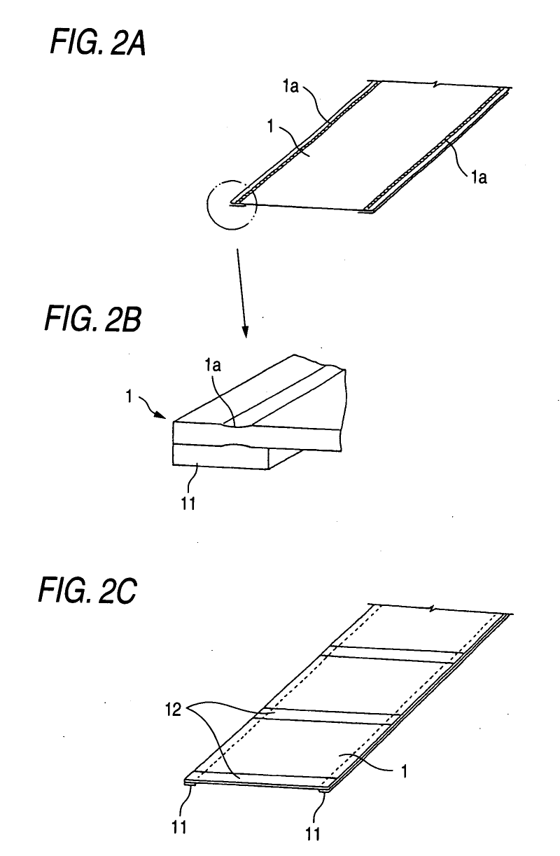

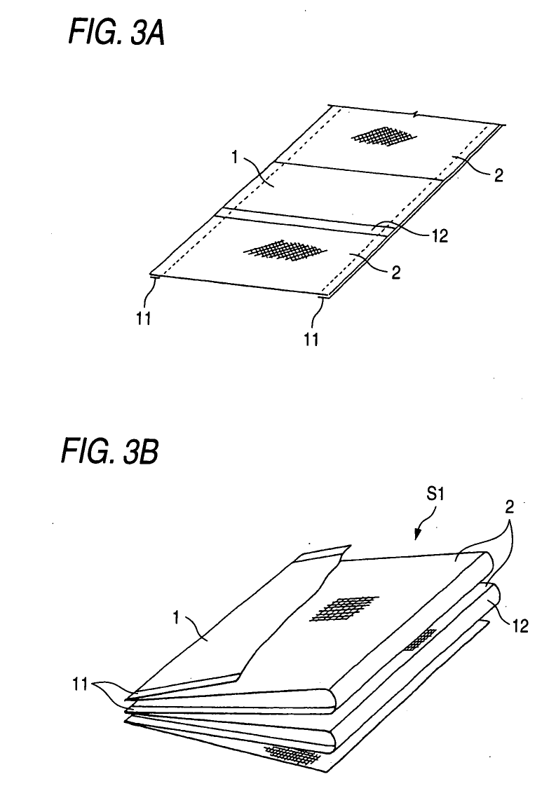

The multilayered object S1 described above can be produced, for example, by the method illustrated in FIG. 2(a) to FIG. 3(b). First, as shown in FIG. 2(a), both side edges of a membrane 1 which is a continuous membrane are partly fusion-bonded thermally (densified) to form fusion-bonded parts 1a in order to heighten the sealability of both edge parts of the membrane 1. The continuous membrane used is, for example, one having a width of from 500 to 2,000 mm, preferably from 900 to 0.1,200 mm. In this case, thermal fusion bonding (heat sealing, ultrasonic welding, or the like) is continuously conducted over a width of up to 50 mm in a region of 100 mm from each edge while unwinding the continuous membrane from a roll. Preferably, thermal fusion bonding is conducted over a width of up to 30 mm in a region of 30 mm from each edge.

As shown in FIG. 2(b), a fusion-bondable tape 11 having a width of from 5 to 100 mm is applied to the edge of the permeation side of each fusion-bonded part 1a at a pressure of from 0.01 to 1 MPa while avoiding wrinkling. Preferably, the tape is applied over a width of from 5 to 30 mm from each edge at a pressure of from 0.01 to 0.5 MPa. The fusion-bondable tape 11 may be one comprising a fusion-bondable base tape and a pressure-sensitive adhesive layer formed thereon. It may also be one having no pressure-sensitive adhesive layer.

As shown in FIG. 2(c), a pressure-sensitive adhesive tape 12 for reinforcement which has a width of from 10 to 100 mm is applied to the feed side of the membrane at the same interval of from 500 to 2,000 mm in the length direction while avoiding wrinkling in the width direction. Preferably, a pressure-sensitive adhesive tape 12 having a width of from 10 to 50 mm is applied at the same interval of from 500 to 1,500 mm in the length direction. The pressure-sensitive adhesive tape 12 may be any of PET tapes and the like. The areas where the adhesive tape 12 is applied are the parts to be turned down or turned up when the membrane is continuously folded.

After application of the pressure-sensitive adhesive tape 12, lines are formed at the parts where creases are to be formed. Thus, assembly precision is improved. Examples of methods for forming the lines include a method in which the membrane is placed on a mold, roll, or the like as a receiving tool and an edged tool or rotary blade which forms a straight line or broken line is pressed from above against the membrane to sandwich it. The width of each line is, for example, from 0.1 to 10 mm, preferably from 0.1 to 3 mm. The load to be applied for the pressing is, for example, from 1 to 500 N, preferably from 1 to 200 N.

As shown in FIG. 3(a), feed-side passage materials 2 having a width of, for example, from 500 to 2,000 mm, preferably from 900 to 1,200 mm, which have been cut into a length of from 500 to 2,000 mm are fixed alternately to the parts to which the pressure-sensitive adhesive tape 12 has been applied. Examples of methods for this fixing include thermal fusion bonding, stapling, and fixing with a tape or resin. However, ultrasonic welding is preferred.

As shown in FIG. 3(b), each part to which the pressure-sensitive adhesive tape 12 having a feed-side passage material 2 fixed thereto has been applied is creased at nearly the center thereof so that the feed-side passage material 2 is located inside. The membrane is thus folded over a length corresponding to the predetermined number of leaves to thereby form a multilayered object S1. The predetermined number of leaves is, for example, from 3 to 40. In the multilayered object S1 thus obtained, the parts to which the feed-side passage materials 2 have not been attached remain uncreased.

Hot pressing is preferably conducted at a temperature of from 30 to 80° C. and an air pressure of from 0.01 to 0.6 MPa for from 1 to 300 seconds in order to increase the strength of the creased parts. More preferably, hot pressing is conducted at a temperature of from 40 to 70° C. and an air pressure of from 0.01 to 0.5 MPa for from 1 to 120 seconds.

As shown in FIG. 1(b), this multilayered object S1 is inserted between the permeation-side passage materials 4 fixed to the porous sheet 10. This insertion may be accomplished, for example, by placing the permeation-side passage materials 4 and the leaves respectively on both sides of a plane and alternately superposing these one after another. This step can be automated. Also usable is a method in which permeation-side passage materials 4 are successively interposed when a folding step such as that shown in FIG. 3(b) is conducted. In the invention, highly efficient production is possible when the multilayered object S1 and the porous sheet 10 to which passage materials have been fixed are prepared beforehand.

In this embodiment, after the multilayered object S1 is inserted to form a multilayer structure S2, the fusion-bondable tapes 11 are used to fix the membrane 1 to those parts of the porous sheet 10 which are located close to the membrane 1, as shown in FIG. 1(c). This fixing is conducted over a length corresponding to the predetermined number of leaves. Besides thermal or ultrasonic fusion bonding with the fusion-bondable tapes 11, examples of methods for the fixing include bonding with an adhesive and bonding with a pressure-sensitive adhesive tape, double-faced pressure-sensitive adhesive tape, or material for thermal fusion bonding. Any of these methods may be used. The precision of this operation is preferably such that the parallelism with the permeation-side passage materials 4 is from 0.01 to 1 degree and the parallelism with the core tube 5 is from 0.01 to 1 degree.

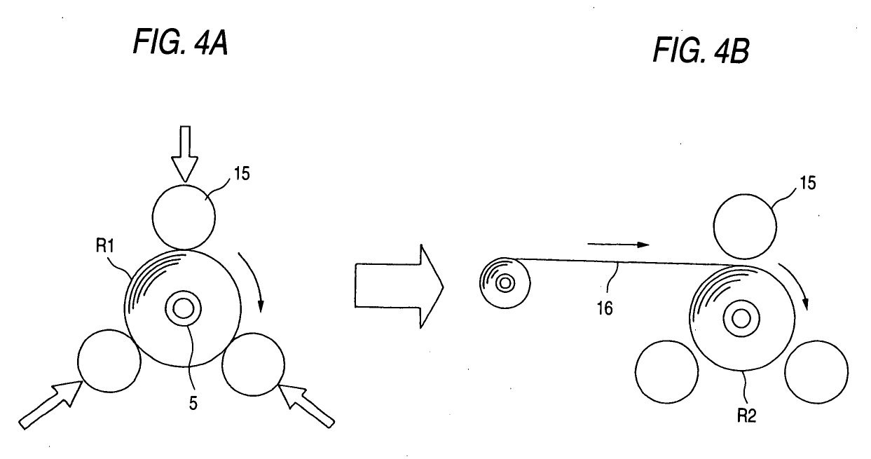

The process of the invention includes the step of spirally winding at least this multilayer structure S2 on the perforated core tube 5 as shown in FIG. 1(d). In this step, the winding is conducted by rotating the core tube 5 while pressing one or more rolls 15 against the periphery of the wound structure R1 as shown in FIG. 4(a).

For rotating the core tube 5, conventional winding apparatus can be used. The core tube 5 is attached to the winding chuck and rotated. The rotational speed is, for example, from 10 mm/min to 50 m/min, preferably from 0.5 to 50 m/min, in terms of the peripheral speed of the wound structure R1. The torque for the rotation is not particularly limited as long as the core tube 5 can be rotated. Namely, since a lower torque suffices to conduct the winding as compared with the tension method, winding at a higher speed is possible to thereby attain an improvement in productivity.

In the operation described above, the number of rolls 15 is, for example, from 1 to 8, preferably 2 or 3. The rolls 15 may be either free-rotating ones or ones having a rotation-breaking force or driving force. It is, however, preferred to employ rolls which are free-rotating or have a slight breaking force.

The rolls 15 preferably have a surface made of a material which is hard to slip. The outer diameter of the rolls 15 is preferably from 25 to 150 mm, more preferably from 50 to 100 mm.

The pressure at which the rolls 15 are pressed against the wound structure R1 may be about from 0.01 to 0.7 MPa, preferably from 0.01 to 0.5 MPa, in terms of the pressure of air supplied, under general conditions in air cylinder pressing. That air pressure range corresponds to linear pressures ranging from 0.75 to 3.70 N/cm.

In the invention, the winding step described above may be conducted to wind the multilayer structure S2 to the final stage. However, a step may be conducted in which during or after completion of the winding, the wound structure R1 is tightened by rotating the core tube 5 while pressing the one or more rolls 15 against the wound structure R1 at a higher pressure. In the case of continuous leaves as in this embodiment, it is possible to provisionally crease the peripheral side of each leaf by conducting the winding up to the final stage. The kind, number, etc., of the rolls 15 to be used in the tightening step may be the same as or difficult from those in the winding step.

In the tightening step, the state of being tightened can be regulated by controlling the pressure and speed. For example, the pressure to be applied to the rolls 15 is preferably higher by from 10 to 30% than the pressure shown above. The speed of the rolls 15 is preferably from 70 to 100% of the speed shown above.

It is preferred in the invention that a sheathing sheet 16 be wound on the wound structure R1 after the winding. This operation can be conducted by a method in which the rolls 15 are released and a sheathing sheet 16 is then wound while applying a tension, as shown in FIG. 4(b). Alternatively, a method can be used in which during or after completion of the tightening step, a sheathing sheet 16 is wound while pressing one or more rolls 15 against the wound structure.

The sheathing sheet 16 preferably is, for example, a tape having a pressure-sensitive adhesive layer or a sheet having adhesiveness. The sheathing sheet 16 is wound to make, for example, from 1 to 200 laps to thereby improve the degree of tightening. Preferably, the sheathing sheet 16 is wound to make from 1 to 50 laps.

In the invention, the step of forming a sealing structure for preventing the feed-side passages from being directly connected to the permeation-side passages is conducted, for example, in the same manner as in a technique heretofore in use. This step may be conducted in any stage and may be conducted in two or more steps. Examples thereof include: a step in which the fusion-bondable tapes 11 are used to seal both edges of the membrane 1, with the permeation-side passage materials 4 being interposed between opposed parts of the membrane 1 on their permeation side; a step in which those parts of both edges of the membrane 1 which are located close to the porous sheet 10 are sealed; and a step in which when not a continuous membrane but leaves are used, the outer edges of the membranes 1 are sealed.

Besides thermal or ultrasonic fusion bonding with the fusion-bondable tapes 11, examples of methods for the sealing include bonding with an adhesive and bonding with a pressure-sensitive adhesive tape, double-faced pressure-sensitive adhesive tape, or material for thermal fusion bonding. Any of these may be used.

After the winding, the wound structure may be heat-treated at an appropriate temperature in order to remove the residual stress from the parts sealed by, e.g., thermal fusion bonding. Alternatively, the winding step may be conducted with, e.g., heating at a temperature which does not separate the parts bonded by, e.g., thermal fusion bonding. It is also possible to wind a peripheral-part passage material such as, e.g., a net around the periphery of the membrane 1 after the winding step.

Other embodiments are described below.

(1) In the embodiment described above, permeation-side passage materials are fixed to a porous sheet so as to utilize a core tube as a permeation-side passage. However, in such cases where cake formation or the like due to concentration polarization is not problematic, feed-side passage materials may be fixed to a porous sheet so as to utilize a core tube as a feed-side passage.

(2) In the embodiment described above, a multilayered object comprising a pleated continuous membrane and feed-side passage materials disposed beforehand on the feed side of the membrane is prepared beforehand and this multilayered object is inserted between permeation-side passage materials. However, a method may be used in which a continuous membrane is first inserted between permeation-side passage materials and then feed-side passage materials are inserted between opposed parts of the continuous membrane.

(3) In the embodiment described above, permeation-side passage materials are fixed beforehand to a porous sheet and wound using the porous sheet. However, a method may be used in which permeation-side passage materials are directly fixed to a core tube by, e.g., ultrasonic fusion bonding and the core tube is then rotated to wind the multilayer structure.

(4) In the embodiment described above, a multilayer structure comprising continuous leaves formed from a continuous membrane is wound. In the invention, however, a method may be used in which two or more independent leaves prepared beforehand are used to form a multilayer structure and this structure is wound on a core tube.

The invention will be explained in more detail by reference to the following Examples specifically showing the constitution of the invention and the effects obtained thereby. It should however be understood that the invention is not construed as being limited to the Examples.

### EXAMPLE 1

A 924 mm-wide membrane (NTR-759HR) manufactured by Nitto Denko Corp. was unwound and, simultaneously therewith, 5-mm heat sealing was continuously conducted in a width of 10 mm from each side edge. A fusion-bondable tape having a width of 20 mm was applied to the edge of the permeation side of each fusion-bonded part at a pressure of 0.05 MPa while avoiding wrinkling. It was ascertained that no wrinkles were formed. A PET tape NO. 31B having a width of 50 mm (manufactured by Nitto Denko Corp.) was applied to the feed side of the membrane at the same interval of 750 mm in the length direction while avoiding wrinkling. After the tape application, a metallic edged tool having a width of 0.5 mm and a mold as a receiving tool were used to form a line at a pressure of 200 N in each part to be creased. A feed-side passage material made of PP and having a width of 924 mm was cut into 750 mm beforehand. The cut feed-side passage materials were fixed alternately to the parts to which the PET tape had been applied. This fixing was conducted with an ultrasonic welder. The passage materials were ascertained to be satisfactorily adhered. Each part to which the PET tape having a feed-side passage material fixed thereto had been applied was creased at nearly the center thereof so that the feed-side passage material was located inside. The membrane was thus folded over a length corresponding to the predetermining number of leaves which was 32. In the multilayered object thus obtained, the parts to which the feed-side passage materials had not been attached remained uncreased. For the purpose of increasing the strength of the creased parts, hot pressing was conducted for 2 seconds at 70° C. and an air pressure of 0.5 MPa. This multilayered object was prepared beforehand as a product to be mounted. It was ascertained that the membrane could be precisely creased along the lines perpendicularly formed, without swelling or being distorted.

On the other hand, a permeation-side passage material made of PET and having a width of 884 mm and a length of 750 mm was attached with ultrasonic to a core tube made of a noryl resin and having an outer diameter of 38 mm and a length of 1,016 mm. The passage material was ascertained to have been satisfactorily attached. This passage material was wound on the core tube so as to make one lap. Subsequently, 884-mm permeation-side passage materials which had been cut in a separate step were fixed by thermal fusion bonding to the attached permeation-side passage material almost the same interval over the length of the periphery of the core tube. The number of these passage materials thus fixed corresponded to the predetermined number of leaves, which was 32. The parallelism between the permeation-side passage materials was ascertained to be 0.01 degree, and the parallelism with the core tube was ascertained to be 0.01 degree.

The multilayered object described above was attached to the thus-obtained permeation-side passage material assembly by thermally fusion-bonding the hot-pressed edges of the leaves of the multilayered object, one by one, to the respective permeation-side passage materials. Thus, the leaves were attached in the predetermined number of 32. The precision of this operation was ascertained to be such that the parallelism with the permeation-side passage materials was 0.01 degree and the parallelism with the core tube was 0.01 degree. The core tube of the resultant assembly was set on a winding chuck. This chuck was wound at a constant speed (20 m/min). In this operation, rolls were pressed from two directions against the element at a constant pressure (air supply pressure, 0.01 MPa) to make the sides even. In the case of continuous leaves, the edges on the periphery side were provisionally creased. After 30 rotations, another roll was further applied to tighten the element. In this operation, the element was wrapped by winding a tape thereon to make 20 laps. As a result, the degree of tightening was further improved. The winding operation was completely free from wrinkling, breakage, and positional shifting, and the desired performances were obtained.

It should further be apparent to those skilled in the art that various changes in form and detail of the invention as shown and described above may be made. It is intended that such changes be included within the spirit and scope of the claims appended hereto.

This application is based on Japanese Patent Application No. 2002-374624 filed Dec. 25, 2002, the disclosure of which is incorporated herein by reference in its entirety.

What is claimed is:

1. A process for producing a spiral membrane element which comprises: the step of forming a multilayer structure including a feed-side passage material interposed between opposed membranes on their feed side and a permeation-side passage material interposed between opposed membranes on their permeation side; the step of spirally winding at least the multilayer structure on a perforated core tube; and the step of forming a sealing structure for preventing the feed-side passages from being directly connected to the permeation-side passages,
the winding of the multilayer structure on the core tube being conducted by rotating the core tube while pressing one or more rolls against the periphery of the wound structure.

2. The process for producing a spiral membrane element as claimed in claim 1, further comprising a step in which during or after completion of the winding, the wound structure is tightened by rotating the core tube while pressing one or more rolls against the wound structure at a higher pressure.

3. The process for producing a spiral membrane element as claimed in claim 2, further comprising a step in which during or after completion of the tightening step, a sheathing sheet is wound on the wound structure while pressing one or more rolls against the wound structure.

4. The process for producing a spiral membrane element as claimed in claim 1, wherein the step of forming a multilayer structure comprises a step in which permeation-side passage materials are fixed each at an end thereof to a porous sheet at a given interval and a step in which a membrane and a feed-side passage material are inserted between the fixed permeation-side passage materials to thereby form the multilayer structure.
